(19) United States
(12) Patent Application Publication
(10) Pub. No.: US 2012/0218087 A1
(43) Pub. Date: Aug. 30, 2012

(54) NETWORK END DEVICE CONFIGURATION SYSTEM

(75) Inventors: Xiaofeng Wang, Rockledge, FL (US); Ronald Ray Larson, Palm Bay, FL (US)

(73) Assignee: GENERAL ELECTRIC COMPANY, Schenectady, NY (US)

(21) Appl. No.: 13/036,459

(22) Filed: Feb. 28, 2011

(51) Int. Cl. G06K 7/01

(52) U.S. Cl. 340/10.41

(57) ABSTRACT

Aspects of the invention provide for a network end device configuration system. In one embodiment, a system is disclosed comprising: at least one computing device adapted to configure an end device to an electrical network by performing actions comprising: obtaining an indicator that the end device has entered the electrical network; querying the end device for global positioning data about the end device in response to the obtaining of the indicator; obtaining the global positioning data about the device; and associating an identification of the end device with the global positioning data about the end device.

### BACKGROUND OF THE INVENTION

The disclosure relates generally to a configuration system for devices on a network. More particularly, the disclosure relates to a configuration system for network end devices in an electrical network.

As an ever-increasing number of end devices are installed on electrical networks, network managers have become interested in tracking and monitoring these devices in their management systems. These devices may include, but are not limited to, remote terminal units (RTUs), smart meters, feeder devices, power management units (PMUs), intelligent electronic devices (IEDs), etc. However managing these devices becomes more and more difficult as their number and variety expands. One of the challenges is to associate these end devices to corresponding network equipment. Current approaches include manually entering data into an electrical network management system each time a new end device is connected to the electrical network, and establishing the connection between end devices and their associated network equipment. In some cases, this involves sending a technician to the location of the device and having the technician enter pertinent data about the device into the management system. This conventional approach can be both costly and time-consuming.

### BRIEF DESCRIPTION OF THE INVENTION

Aspects of the invention provide for a network end device and equipment configuration system. In one embodiment, aspects of the invention include a system comprising: at least one computing device adapted to configure an end device to an electrical network by performing actions comprising: obtaining an indicator that the end device has entered the electrical network; querying the end device for global positioning data about the end device in response to the obtaining of the indicator; obtaining the global positioning data about the device; and associating an identification of the end device with the global positioning data about the end device.

A first aspect of the disclosure provides for a system comprising: at least one computing device adapted to configure an end device to an electrical network by performing actions comprising: obtaining an indicator that the end device has entered the electrical network; querying the end device for global positioning data about the end device in response to the obtaining of the indicator; obtaining the global positioning data about the device; and associating an identification of the end device with the global positioning data about the end device.

A second aspect of the disclosure provides for a program product stored on a computer readable medium, which when executed by at least one computing device, performs the following: obtains an indicator that the end device has entered the electrical network; queries the end device for global positioning data about the end device in response to the obtaining of the indicator; obtains the global positioning data about the device; and associates an identification of the end device with the global positioning data about the end device.

A third aspect of the disclosure provides for a system comprising: an electrical network including a plurality of network nodes and network equipment; and at least one computing device operably connected to the electrical network, the at least one computing device adapted to configure an end device to one of the plurality of network nodes of the electrical network by performing actions comprising: obtaining an indicator that the end device has connected to the one of the plurality of network nodes or the network equipment; querying the end device for global positioning data about the end device in response to the obtaining of the indicator; obtaining the global positioning data about the end device, and obtaining global positioning data about at least one of the one of the plurality of network nodes or the network equipment; and associating an identification of the end device with the global positioning data about at least one of: the end device, the one of the plurality of network nodes and the network equipment.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an environment including an end device configuration system according to embodiments of the invention.

FIG. 2 shows a schematic flow diagram illustrating a method of configuring end devices in an electrical network according to embodiments of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a configuration system for devices on a network. More particularly, the disclosure relates to a configuration system for network end devices in an electrical network.

As described herein, an ever-increasing number of end devices are being installed on electrical networks. Managing these end devices and associating these end devices with network nodes and/or network equipment has become more and more difficult as the number and types of devices increase. These devices may include, but are not limited to, remote terminal units (RTUs), smart meters, feeder devices, power management units (PMUs), intelligent electronic devices (IEDs), etc. Current approaches include manually entering data into an electrical network management system each time a new end device is connected to the electrical network. In some cases, this involves sending a technician to the location of the device and having the technician enter pertinent data about the device into the management system. For example, in some conventional approaches, a utility provider may send a technician to a site for installation of one or more end devices on the electrical network. The technician will conventionally track (either via physical notes or entries into a data program) the end device identification (ID) information and location information as to where the end device is physically installed at the site. Upon completion of the installation, the technician provides the ID information and corresponding physical location (e.g., via a work order) so that such information may be entered in a network management system. This conventional approach requires not only sending technicians to the site, but also requires manual tracking and association of end device IDs and physical locations of the devices on the electrical network.

In contrast to the conventional approaches, aspects of the invention provide for a system configured to locate and connect an end device to an electrical network using global positioning system (GPS) data. In one embodiment, aspects of the invention provide for an end device configuration system adapted to query an end device (including an embedded GPS component) for GPS data in response to receiving an indicator that the end device has joined the electrical network. The indicator may be provided through an automatic signal transmitted by the end device when it joins the electrical network. In another embodiment, the indicator may be provided in response to a query (e.g., a continuous, or periodic query) sent by the end device configuration system to search for any new end devices on the electrical network. In either case, in response to receiving the indicator that the end device has joined the electrical network, the end device configuration system queries the end device for GPS data to determine a physical location of the end device. The end device configuration system can then associate the end device ID with the physical location in the electrical network.

Other aspects of the invention allow for providing an installer (e.g., a human technician) with a GPS-enabled device (e.g., a handheld device) that interacts with the end device configuration system. In this case, in response to receiving an indicator that the end device has joined (e.g., via installation by the installer) the electrical network, end device configuration system may query a mobile device provided to the installer for GPS data. In one embodiment, the installer carries the mobile device and the end device configuration system simply queries the device after the end device enters the network (e.g., after attachment to a network node). In another embodiment, the end device configuration system prompts the technician to transmit GPS data from his mobile device after receiving the indicator that the end device has entered the network. The technician may then respond by transmitting GPS data from the mobile device (e.g., by enabling a GPS-based application, responding to a query, or otherwise enabling a GPS tracking mechanism) to the end device configuration system.

As will be appreciated by one skilled in the art, the end device configuration system described herein may be embodied as a system(s), method(s) or computer program product(s), e.g., as part of an electrical grid monitoring system. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described herein with reference to data flow illustrations and/or block diagrams of methods, apparatus (systems) and computer program products according to embodiments of the invention. It will be understood that each block of the data flow illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

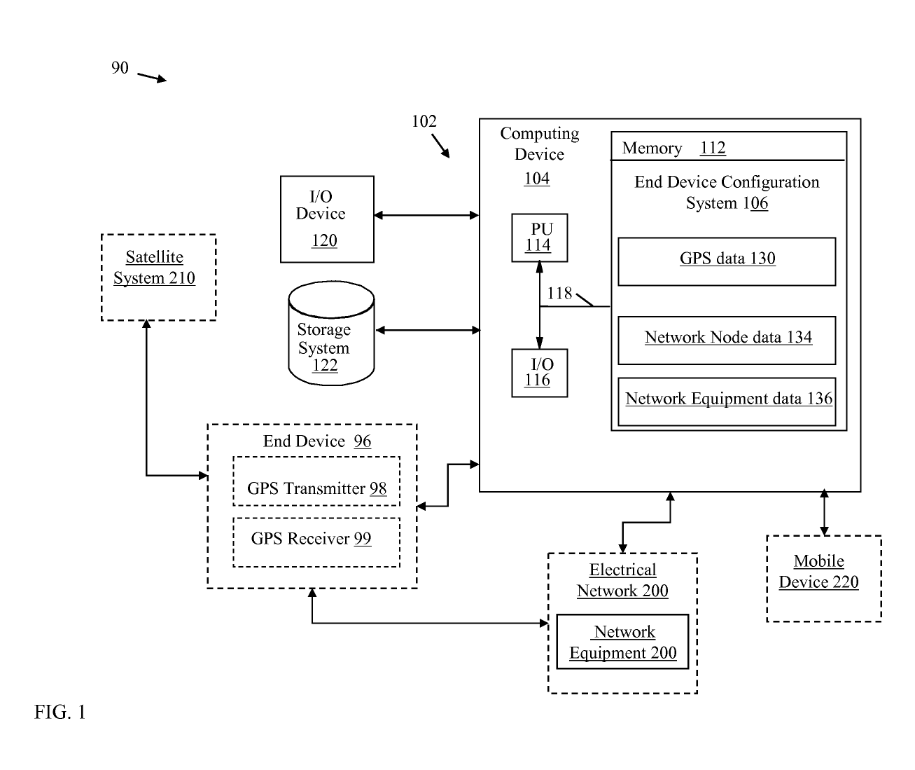

Turning to FIG. 1, an illustrative environment 90 including an end device configuration system 106 is shown according to embodiments of the invention. Environment 90 includes a computer infrastructure 102 that can perform the various processes described herein. In particular, computer infrastructure 102 is shown including a computing device 104 that comprises the end device configuration system 106, which enables computing device 104 to configure an end device 96 in the electrical network 200 (along with its associated network equipment 205) by performing the process steps of the disclosure.

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as end device configuration system 106, that is stored in memory 112 and/or storage system 122. While executing computer program code, processor 114 can read and/or write data, such as global positioning system (GPS) data 130, network node data 134 and/or network equipment data 136 to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In some embodiments, as shown in FIG. 1, environment 90 may optionally include end device 96 and electrical network 200 (including network equipment 205) operably connected to the end device configuration system 106 through computing device 104 (e.g., via wireless or hard-wired means). In one embodiment, end device 96 may include a GPS transmitter 98 for transmitting GPS data 130 to end device configuration system 106, and a GPS receiver 99 for receiving GPS data 130 from, e.g., a satellite system 210. It is understood that end device configuration system 106 may further include conventional transmitters and receivers for transmitting and receiving, respectively, data from the end device 96 and/or the electrical network 200. Environment 90 may further optionally include a satellite system 210 for providing GPS data 130 to the end device 96 via conventional means.

In any event, computing device 104 can comprise any general purpose computing article of manufacture capable of executing computer program code installed by a user (e.g., a personal computer, server, handheld device, etc.). However, it is understood that computing device 104 and end device configuration system 106 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, end device configuration system 106 has the technical effect of enabling computing infrastructure 102 to perform, among other things, the network configuration functions described herein. It is understood that some of the various components shown in FIG. 1 can be implemented independently, combined, and/or stored in memory for one or more separate computing devices that are included in computer infrastructure 102. Further, it is understood that some of the components and/or functionality may not be implemented, or additional schemas and/or functionality may be included as part of environment 90.

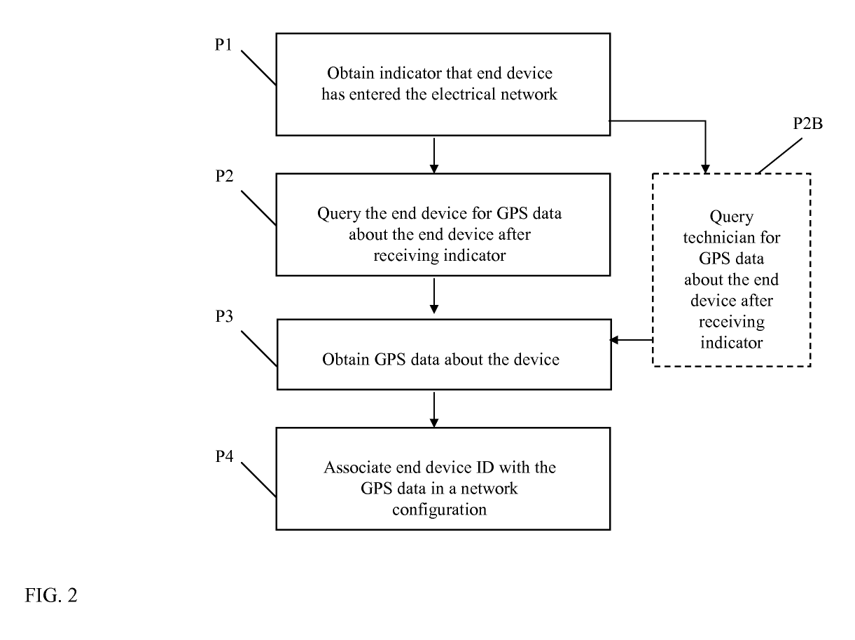

FIG. 2 shows an illustrative flow diagram depicting a method according to embodiments of the invention. As shown, in process P1, the end device configuration system 106 may obtain an indicator that the end device 96 has entered the electrical network 200 (e.g., via connection to a component of network equipment 205). This may include obtaining network node data 134 and/or network equipment data 136 from the electrical network 200, indicating that an end device 96 has been connected to one of the network nodes (via, e.g., network equipment at that node). As described herein, end device configuration system 106 may obtain this indicator in different manners, e.g., via a periodic query and response of the network nodes, via a signal transmitted from the network node in response to connection of the end device 96, etc. In another embodiment, the end device 96 may transmit a signal, e.g., via the network node, to the end device configuration system 106, the signal indicating that the end device 96 has joined the network. In any case, after obtaining the indicator that end device 96 has entered the electrical network 200, in processes P2-P3, end device configuration system 106 may query the end device 96 for global positioning data (GPS data) 130 about the end device 96 and obtain that GPS data 130. This may include sending a query signal to the end device 96 requesting GPS data 130. In turn, in one embodiment, the end device 96 may query a conventional satellite system 210 for its GPS data 130. However, in other embodiments, end device 96 may already have its GPS data 130 available (e.g, via triangulation with nearby devices or displacement relative to previously obtained GPS data).

In any case, after querying end device 96 for its GPS data 130, in process P3, end device configuration system 106 may obtain the GPS data 130. In one embodiment, end device 96 may transmit its GPS data 130 directly to end device configuration system 106 (e.g., via wireless means). However, in another embodiment, end device 96 may transmit its GPS data 130 via the electrical network 200 to end device configuration system 106 (e.g., via wireless or hard-wired means).

In any case, after obtaining the GPS data 130 about end device 96, in process P4, end device configuration system 106 may then associate an end device identification (ID) (such as an end device identification number known by the network manager and pre-assigned to different end devices) with the GPS data 130 for the end device 96. This may include linking the end device ID number (or code, or other indicator of end device identification) with a physical location in space (as provided by GPS data 130). Further, the end device ID and its physical location may be linked with the network node location to associate the end device 96 with one or more node(s) in the electrical network 200. In any case, end device configuration system 106 may associate a physical location of end device 96 with an end device ID, thereby providing information about the end device 96 relative to the network for facilitating network communication, upgrades, etc.

In an alternative embodiment (indicated by optional process P2B), a technician in the field may be queried via a mobile device 220 to provide GPS data 130 to end device configuration system 106. For example, as described herein, after end device 96 is detected in the electrical network 200 (via, e.g., connection to a network node), end device configuration system 106 transmits a signal to the mobile device 220 of the technician requesting GPS data 130 about end device 96. In this case, the technician may activate a request for GPS data 130 from the satellite system 210 from end device 96, or from his mobile device 220. In another case, in this alternative process P2B, the technician may provide GPS data (similar to, e.g., GPS data 130) about the location of the mobile device 220 to the end device configuration system 106 during the installation process. Following alternative process P2B, process P3 and Process P4 may be repeated as described herein. Specifically, as described herein, in process P3 the end device configuration system 106 may obtain the GPS data 130 (including location of the mobile device 220 carried by the technician), and in process P4, end device configuration system 106 may then associate that location with the end device ID (assuming that the technician remains proximate to the end device 96 during transmission). It is understood that in the alternative process described with reference to process P2B, that GPS data 130 may be obtained from the technician's mobile device 220 in relatively real-time, or, alternatively, the GPS data 130 may be obtained from the technician's mobile device 220 and stored for later use by end device configuration system 106 (in any way described herein).

It is understood that as described herein, end device 96 may include one or more conventional end devices including but not limited to: a remote terminal unit, a smart meter, a feeder device, a power management unit, and an intelligent electronic device. It is further understood that the term “end device” is intended merely to connote that these devices are located proximate to the network nodes. The term “end device” is not intended to suggest that additional devices cannot be connected through these end devices, but is merely a general reference to their location on the network.

It is further understood that, as is known in the art, the electrical network may include network equipment, including, but not limited to, a plurality of circuit breakers (not specifically shown) for controlling one or more circuits in the network. In some embodiments, the distinct circuit breakers may have distinct operating protocols. In some embodiments, e.g., where the end device 96 includes a remote terminal unit (RTU), the end device 96 may be connected to two or more of the circuit breakers (e.g., those having distinct operating protocols). In this case, end device 96 may be connected to (and in some cases, partially control) at least two distinct circuits in the electrical network. Aspects of the invention allow for configuration of the end device 96 in the network such that a network management system may have knowledge of where the end device 96 is located in the electrical network 200, as well as to which circuit breakers it is connected. In contrast to conventional approaches, this configuration may be performed with reduced field costs (e.g., technician time, effort, etc.)

The data flow diagram and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “obtaining” data (e.g., temperatures, grid frequency, etc.). It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system comprising:
at least one computing device adapted to configure an end device to an electrical network by performing actions comprising:
obtaining an indicator that the end device has entered the electrical network;
querying the end device for global positioning data about the end device in response to the obtaining of the indicator;
obtaining the global positioning data about the device; and
associating an identification of the end device with the global positioning data about the end device.

2. The system of claim 1, wherein the at least one computing device is further adapted to send a query through the electrical network to determine whether the end device has entered the electrical network.

3. The system of claim 2, wherein the obtaining of the indicator includes receiving a returned response signal indicating that the end device has entered the electrical network.

4. The system of claim 1, wherein the end device is selected from the group consisting of: a remote terminal unit, a smart meter, a feeder device, a power management unit, and an intelligent electronic device.

5. The system of claim 4, wherein the electrical network includes a plurality of network equipment and a plurality of network nodes, and wherein the end device is connected to at least one of each of the plurality of network equipment and the plurality of network nodes.

6. The system of claim 4, wherein the end device includes a GPS transmitter.

7. A program product stored on a computer readable medium, which when executed by at least one computing device, performs the following:
obtains an indicator that the end device has entered the electrical network;
queries the end device for global positioning data about the end device in response to the obtaining of the indicator;
obtains the global positioning data about the device; and
associates an identification of the end device with the global positioning data about the end device.

8. The program product of claim 7, wherein the at least one computing device is further adapted to send a query through the electrical network to determine whether the end device has entered the electrical network.

9. The program product of claim 8, wherein the obtaining of the indicator includes receiving a returned response signal indicating that the end device has entered the electrical network.

10. The system of claim 7, wherein the end device is selected from the group consisting of: a remote terminal unit, a smart meter, a feeder device, a power management unit, an intelligent electronic devices and a programmable communicating thermostat.

11. The system of claim 10, wherein the electrical network includes a plurality of network equipment and a plurality of network nodes, and wherein the end device is connected to at least one of each of the plurality of network equipment and the plurality of network nodes.

12. The system of claim 10, wherein the end device includes a GPS transmitter.

13. A system comprising:
an electrical network including a plurality of network nodes and network equipment; and
at least one computing device operably connected to the electrical network, the at least one computing device adapted to configure an end device to one of the plurality of network nodes of the electrical network by performing actions comprising:
obtaining an indicator that the end device has connected to the one of the plurality of network nodes or the network equipment;
querying the end device for global positioning data about the end device in response to the obtaining of the indicator;
obtaining the global positioning data about the end device, and obtaining global positioning data about at least one of the one of the plurality of network nodes or the network equipment; and
associating an identification of the end device with the global positioning data about at least one of: the end device, the one of the plurality of network nodes and the network equipment.

14. The system of claim 13, wherein the at least one computing device is further adapted to send a query through the electrical network to determine whether the end device has connected to the one of the plurality of network nodes or the network equipment.

15. The program product of claim 14, wherein the obtaining of the indicator includes receiving a returned response signal indicating that the end device has connected to the one of the plurality of network nodes or the network equipment.

16. The system of claim 13, wherein the end device is selected from the group consisting of: a remote terminal unit, a smart meter, a feeder device, a power management unit, and an intelligent electronic device.

17. The system of claim 16, wherein the end device includes a GPS transmitter.

18. The system of claim 16, wherein the end device is operably connected to at least two distinct components of the network equipment.

19. The system of claim 18, wherein the at least two distinct components of the network equipment have distinct operating protocols.
